(19) United States
(12) Patent Application Publication
(10) Pub. No.: US 2008/0132231 A1
(43) Pub. Date: Jun. 5, 2008

(54) METHODS AND SYSTEMS TO SUPPORT MOBILITY BETWEEN WIRELESS LOCAL AREA NETWORK (WLAN) AND WIRELESS WIDE AREA NETWORK (WWAN) DOMAINS

(75) Inventor: Srinivasan Balasubramanian, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/950,137

(22) Filed: Dec. 4, 2007

Related U.S. Application Data
(60) Provisional application No. 60/868,699, filed on Dec. 5, 2006.

(51) Int. Cl. H04Q 7/20

(52) U.S. Cl. 455/435.1

(57) ABSTRACT

Methods and systems to facilitate mobility of devices between WWAN and WLAN systems/domains are described herein. A mobile station is registered with a preferred system/domain and a non-preferred system/domain and uses one or more public identities and one or more associated private identities to perform registrations over the preferred and non-preferred systems/domains. One or more of the associated systems/domains are further monitored for a paging signal transmitted over the network. In response to the paging signal, the mobile station transmits a paging response signal over the system/domain that facilitated transmission of the paging signal.

### CLAIM OF PRIORITY UNDER 35 U.S.C. §119

The present Application for Patent claims the benefit of and priority to Provisional Application No. 60/868,699, filed on Dec. 5, 2006, and entitled “Supporting Mobility Without Voice Call Continuity Between WLAN/IMS Domains and 3G Domains,” which is hereby expressly incorporated by reference herein.

### BACKGROUND

I. Field

The present disclosure relates generally to wireless communications and, more specifically, to techniques for supporting device mobility between wireless networks.

II. Background

Electronic devices can include multiple communication protocols. For example, mobile devices have become multifunctional devices, frequently providing email, Internet access, as well as traditional cellular communications. Mobile devices can be equipped with wide area wireless connectivity, for example, utilizing the following technologies: third generation wireless or cellular systems (3G), Institute for Electrical and Electronic Engineers (IEEE) 802.16 (WiMax), and other to-be-defined Wireless Wide Area Network (WWAN) technologies. Meanwhile, IEEE 802.11 based Wireless Local Area Network (WLAN) connectivity is being installed in mobile devices as well. In addition, ultra-wideband (UWB) and/or Bluetooth-based Wireless Personal Area Network (WPAN) local connectivity may also be available in mobile devices.

Other examples of multiple communication protocols in electronic devices include a laptop that may include a WPAN utilized to connect the laptop to a wireless mouse, wireless keyboard, and the like. In addition, the laptop may include an IEEE 802.11b or 802.11g device to allow the laptop to communicate with a WLAN. WLAN has become popular and, for example, is being set up in homes for both personal and business purposes. In addition, coffee shops, Internet cafes, libraries and public and private organizations utilize WLANs.

WWAN technologies are distinguished by wide area (ubiquitous) coverage and wide area deployments. However, they may suffer from building penetration losses, coverage holes and, comparatively to WLAN and WPAN, may also suffer from limited bandwidth. WLAN and WPAN technologies deliver very high data rates, approaching hundreds of Mbps, but coverage is typically limited to hundreds of feet in the case of WLAN and tens of feet in the case of WPAN.

The number of networks and protocols continues to increase rapidly due to demands for functionality associated with unique user demands and divergent protocols. Such disparate networks and protocols are laborious for a user to switch between and, in many cases, the user is trapped in a network without regard to what might be the optimal network for the user at a given time. In view of the foregoing, it would be advantageous to provide for seamless transition between networks and/or protocols for optimizing and converging on the best communication protocol for the user.

### SUMMARY

Methods and systems to facilitate mobility of devices between WWAN and WLAN systems/domains are described herein. A mobile station is registered with a preferred system/domain and a non-preferred system/domain and uses one or more public identities and one or more associated private identities to perform registrations over the preferred and non-preferred systems/domains. One or more of the associated systems/domains are further monitored for a paging signal transmitted over the network. In response to the paging signal, the mobile station transmits a paging response signal over the system/domain that facilitated transmission of the paging signal.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 illustrates a multiple access wireless communication system, according to one exemplary embodiment of the invention;

FIG. 2 illustrates an exemplary deployment with WWAN and WLAN systems;

FIG. 3 is a block diagram of a mobile device within the wireless communication system, according to one embodiment of the invention;

FIG. 4 illustrates the relationship between various IMS identities and the mobile device, according to one embodiment of the invention;

FIG. 5 is a block diagram illustrating a method to facilitate mobility of a mobile device over different domains within a network, according to one embodiment of the invention;

FIG. 6 is a block diagram illustrating a method to facilitate mobility of a mobile device over different domains within a network, according to an alternate embodiment of the invention;

FIG. 7 is an interaction diagram for a method to facilitate mobility of a mobile device over different domains within a network, according to one embodiment of the invention;

FIG. 8 is an interaction diagram for a method to facilitate mobility of a mobile device over different domains within a network, according to an alternate embodiment of the invention;

FIG. 9 is an interaction diagram for a method to facilitate mobility of a mobile device over different domains within a network, according to another alternate embodiment of the invention;

FIG. 10 is an interaction diagram for a method to facilitate mobility of a mobile device over different domains within a network, according to a further alternate embodiment of the invention;

FIG. 11 is an interaction diagram for a method to facilitate mobility of a mobile device over different domains within a network, according to yet another alternate embodiment of the invention;

FIG. 12 is a block diagram illustrating a method to facilitate mobility of a mobile device over different domains within a network, according to another alternate embodiment of the invention.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs. The disclosed embodiments may be applied to any one or combinations of the following technologies: Code Division Multiple Access (CDMA) systems, Multiple-Carrier CDMA (MC-CDMA), Wideband CDMA (W-CDMA), High-Speed Packet Access (HSPA, HSPA+), Time Division Multiple Access (TDMA) systems, Frequency Division Multiple Access (FDMA) systems, Orthogonal Frequency Division Multiple Access (OFDMA) systems, or other multiple access techniques. A wireless communication system may be designed to implement one or more standards, such as IS-95, cdma2000, IS-856, W-CDMA, TD-SCDMA, and other standards. In addition, the disclosed embodiments may be applied to 3GPP (Re199, Re15, Re16, Re17) technology, as well as 3GPP2 (1xRTT, 1xEV-DO Re10, RevA, RevB) technology and other known and related technologies.

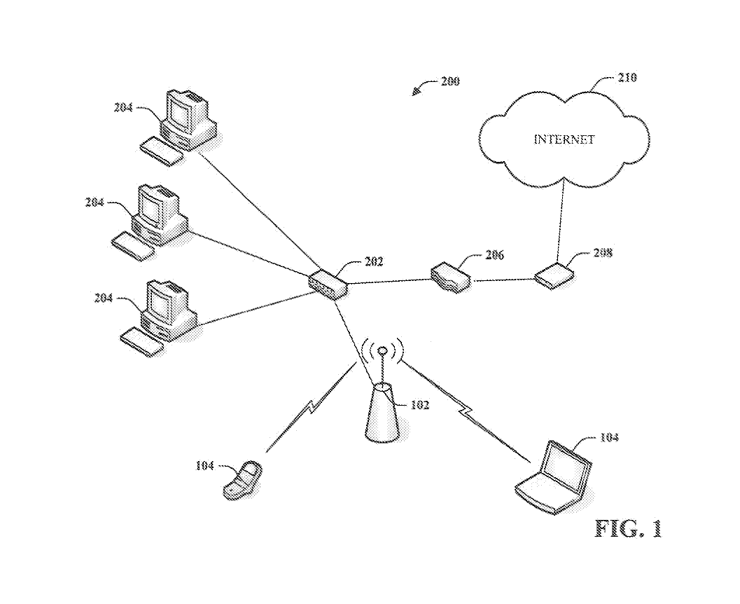

FIG. 1 illustrates a multiple access wireless communication system, according to one exemplary embodiment of the disclosure. As shown in FIG. 1, in one embodiment, the system 200 includes a WLAN associated with a wired local area network (LAN). An access point (AP) 102 within the system 200 is in communication with one or more mobile devices 104. The access point 102 is further connected to an Ethernet hub or switch 202 for a LAN. In some embodiments, the Ethernet hub 202 may be connected to one or more electronic devices 204 that may include, for example, personal computers, peripheral devices (e.g., facsimile machines, copiers, printers, scanners, etc.), servers, and the like. The Ethernet hub 202 may be further connected to a router 206 that transmits data packets to a modem 208. The modem 208 further transmits data packets to a wide area network (WAN) 210, such as the Internet. The system 200 illustrates a single, simple network configuration. Many additional configurations of the system 200, including, for example, alternative electronic devices, are possible. Although the system 200 has been illustrated and described with reference to a LAN, it is to be understood that the system 200 may utilize other technologies, including for example WWAN and/or WPAN, either separately and/or concurrently.

In one embodiment, the system 200 facilitates seamless switching of a mobile device 104 between an access point currently being utilized by the mobile device 104 and an access point 102 associated with the system 200. Such transfer to the access point 102 and to the network supported by the access point 102 may be selected to provide a user of the mobile device 104 a sought after functionality and may be a function of the mobile device 104 location or the data the user desires to access or upload to mobile device 104. By way of example and not limitation, the wireless device 104 may be coupled to electronic device(s) 204 to utilize the WWAN and/or WLAN functionality available through the electronic device(s) 204. In one embodiment, such a transition may be user initiated or, in the alternative, may be performed autonomously by the system 200.

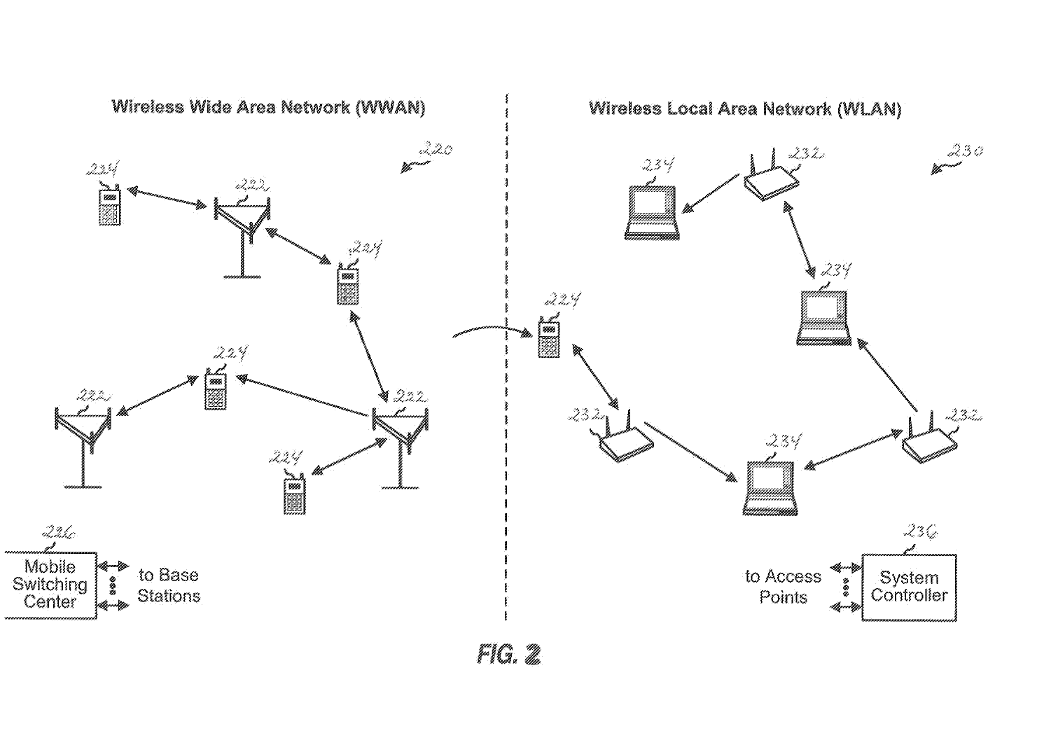

FIG. 2 illustrates an exemplary deployment with WWAN and WLAN systems. In one embodiment, a WWAN 220, or circuit-switched (CS) network, provides communication coverage for a large geographic area, e.g., a city, a state, and so on. A WLAN 230 provides communication coverage for a smaller geographic area, e.g., a mall, a campus, a store, and so on. The coverage area of the WWAN 220 may or may not overlap the coverage area of the WLAN 230.

In one embodiment, the WWAN 220 may be a 1x network, a 1xEV-DO network, or some other known type of network. The WWAN 220 further includes many base stations 222 that support communication for wireless devices 224 within the coverage area of the WWAN 220. For simplicity, only three base stations 222 are shown in FIG. 2 for the WWAN 220. A base station is a fixed station that communicates with the wireless devices and may also be called a base transceiver station (BTS) (1x terminology), an access point (1xEV-DO terminology), or some other terminology. The wireless devices 224 are located throughout the coverage areas of WWAN 220. A wireless device may also be called a mobile station (1x terminology), a user/access terminal (1xEV-DO terminology), a user equipment (UE), a mobile equipment (ME), a subscriber unit, or some other terminology. A wireless device may be a cellular phone, a personal digital assistant (PDA), a wireless modem, a handset, and/or other know devices. A mobile switching center (MSC) 226 provides coordination and control for base stations 222 in WWAN 220.

In one embodiment, the WLAN 230 may be an IEEE 802.11 network or some other type of network. The WLAN 230 may implement one or more standards such as IEEE Std 802.11a-1999 (commonly called “802.11a”), IEEE Std 802.11b-1999 (commonly called “802.11b”), IEEE Std 802.11g-2003 (commonly called “802.11g”), and others, which are known in the art. The WLAN 230 may include one or more access points 232 that support communication for wireless terminals 234 (e.g., laptop computers) and wireless devices 222 within the coverage area of the WLAN 230. For simplicity, only three access points 232 are shown in FIG. 2 for WLAN 230. For a centralized architecture, a system controller 236 provides coordination and control for the access points 232 in the WLAN 230.

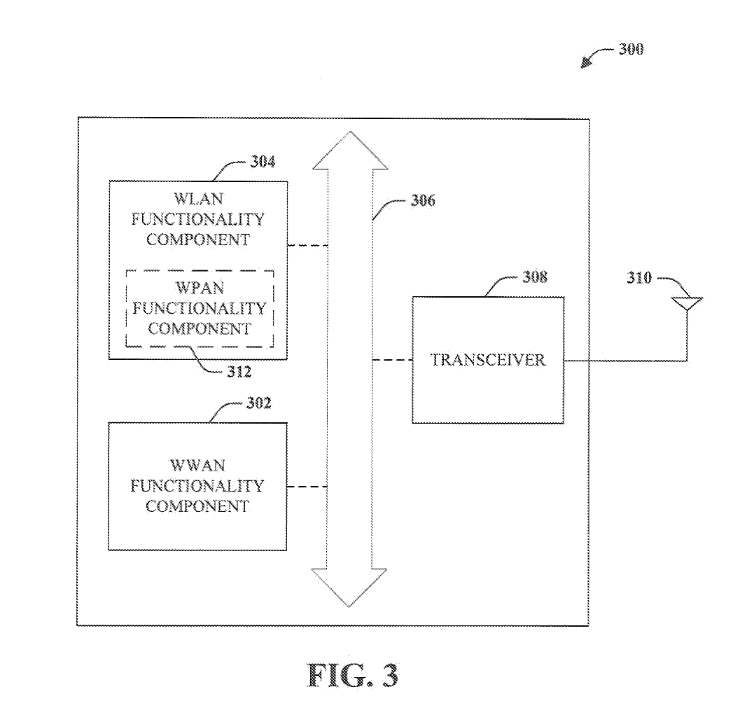

FIG. 3 is a block diagram of a mobile device within the wireless communication system, according to one embodiment of the disclosure. As shown in FIG. 3, in one embodiment, a mobile device 300, also known interchangeably as a mobile station, may include WWAN functionality (e.g., Code-Division Multiple Access (CDMA), Wideband Code-Vision Multiple Access (WCDMA), or Orthogonal Frequency Divison Multiple Access (OFDMA)), WLAN functionality (e.g. IEEE 802.11), and/or related technologies.

In one embodiment, a WWAN component or module 302 that provides WWAN/3G domain functionality and a WLAN component or module 304 that provides WLAN/IMS domain functionality are located together and are capable of communicating with a transceiver 308 through a bus 306 or other known structures or devices. It is to be understood that communication means other than busses could be utilized with the disclosed embodiments, without departing from the spirit or scope of the invention. The transceiver 308 is further coupled to one or more antennas 310 to enable transmission and/or reception by the mobile device 300.

In one embodiment, the WLAN functionality component/module 304 generates voice data provided to the transceiver 308 for communication. In an alternate embodiment, the WWAN functionality component/module 302 and/or the WLAN functionality component/module 304 may be included in a processor within the mobile device 300. In another embodiment, WWAN functionality and WLAN functionality may be provided by distinct integrated circuits. In a further embodiment, WWAN functionality and WLAN functionality may be provided by one or more integrated circuits, processors, ASICs, FPGAs, combinations thereof, or the like including such functionality. The mobile device 300 is equipped with connectivity options for the wide area (WWAN) and local area (WLAN and WPAN) to allow a rich combination of services and user experiences.

In one embodiment, the WLAN functionality component/module 304 may include an optional WPAN functionality component or module 312. The mobile device 300 can connect to either the WWAN or WLAN and WPAN, or to both simultaneously, based upon one or more criteria that relate to functions of the mobile device 300. Furthermore, the process and criteria for switching between each of the networks and/or protocols may also be provided. The criteria may be further stored in a memory within the mobile device 300 and a processor coupled to the memory may analyze one or more networks based on the stored criteria.

In one embodiment, a VCC AS (voice call continuity application server) node (not shown) may be further provided to maintain the domain where the MS may be paged to acquire the call. In certain embodiments, the present disclosure addresses the issue of supporting mobility prior to the availability of the VCC AS. Also the VCC AS may be supported in phases—1) Only domain registration 2) Actual call continuity between IMS and CS domain. This disclosure also suggests mechanisms to adapt the VCC AS capabilities.

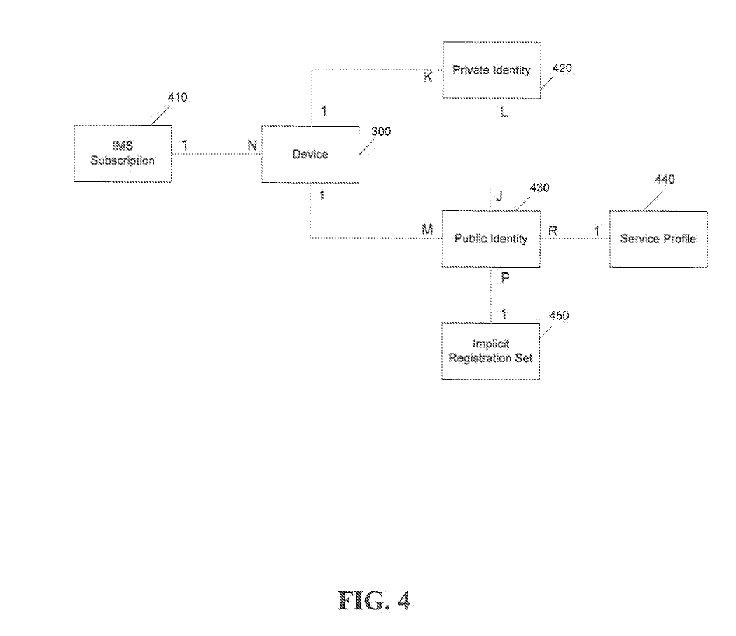

FIG. 4 illustrates the relationship between various IMS identities and the mobile device, according to one embodiment of the invention. In one embodiment, if the mobile device 300 is in voice traffic over a WLAN system and is moving out of the currently associated access point (AP) coverage, the mobile device 300 tries to continue the voice communication over another neighboring access point (AP). The mobile device 300 allows for both single and dual identity configurations and stays dual registered only during transition time periods, as coverage of one radio is growing weak and it needs to hand over the mobile device to the other network, and/or when a partial set of services are available over the WLAN domain. In one embodiment, dual registration does not imply that the mobile device 300 will monitor both systems and allows for the network to find the mobile device 300 within one of the two domains.

As shown in FIG. 4, in one embodiment, the registration of the mobile device 300 in the WWAN (circuit-switched) domain is treated independently of the device's registration in the WLAN/IMS domain. The mobile can be registered in the CS domain while it has been registered using the public identity(ies) in the 3G and/or WLAN domains. The coordination between the CS domain and the IMS domain(s) is handled at the network.

In one embodiment, an IMS subscription 410 may be invoked from the mobile device 300. The device 300 is associated with one or more private identities 420 and one or more public identities 430. Each public identity 430 may correspond to one or more private identities and each private identity 420 may correspond to one or more public identities 430. In one embodiment, all associations among the private and public identities are stored within a service profile 440 associated with the mobile device 300, which the user is allowed to access. The service profile 440 contains a predetermined number of services that each respective public identity 430 associated with the mobile device 300 may support. In one embodiment, an implicit registration set 450 is also coupled to each public identity 430. The implicit registration set 450 monitors the registration of the mobile device 300 and ensures that the mobile device 300 is always registered with a preferred domain. The implicit registration set 450 also enables implicit removal of a registration in a different domain.

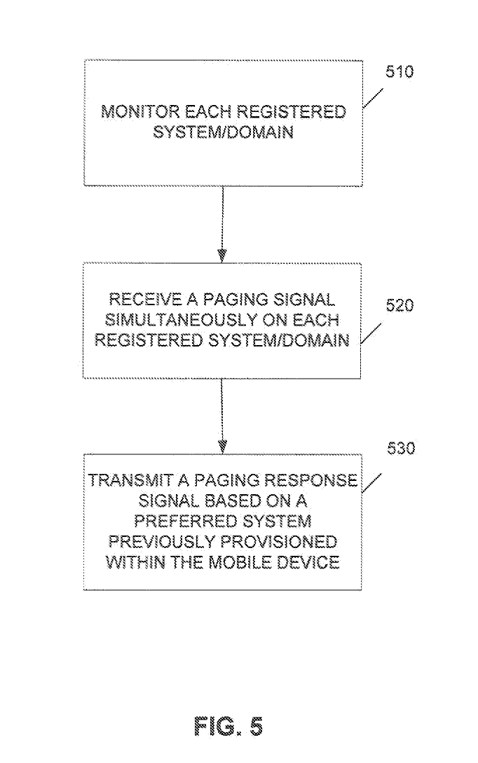

FIG. 5 is a block diagram illustrating a method to facilitate mobility of a mobile device over different domains within a network, according to one embodiment of the invention. In one embodiment, the mobile device 300, also known interchangeably as user equipment (UE), uses a single public identity 430 with a single or, in the alternative, with dual private identities 420 that are used to perform IMS registrations over the WLAN and the WWAN systems/domains. As shown in FIG. 5, at processing block 510, each registered system/domain is monitored. In one embodiment, the mobile device/UE 300 is dual registered on both the WLAN/IMS and CS networks and is monitoring each registered system/domain for paging signals. The network pages the mobile device 300 on both domains simultaneously.

At processing block 520, a paging signal is received simultaneously on each registered system/domain. In one embodiment, the mobile device 300 receives the paging signal from both systems/domains. At processing block 530, a paging response signal is transmitted based on preferred system/domain information provisioned within the mobile device 300. In on embodiment, the mobile device 300 responds to the paging signal based on the preferred system provisioned in the device. The network then processes the paging response received from either system/domain.

In one exemplary embodiment, if a preferred system/domain is identified by the operator and a Paging signal is received over the other system, then the UE 300 waits for a predetermined time period to receive the Paging signal on the preferred system/domain. The UE 300 then sends the paging response signal only over one system/domain. In an alternate embodiment, the UE 300 sends a RejectOrder signal on the non-preferred solutions.

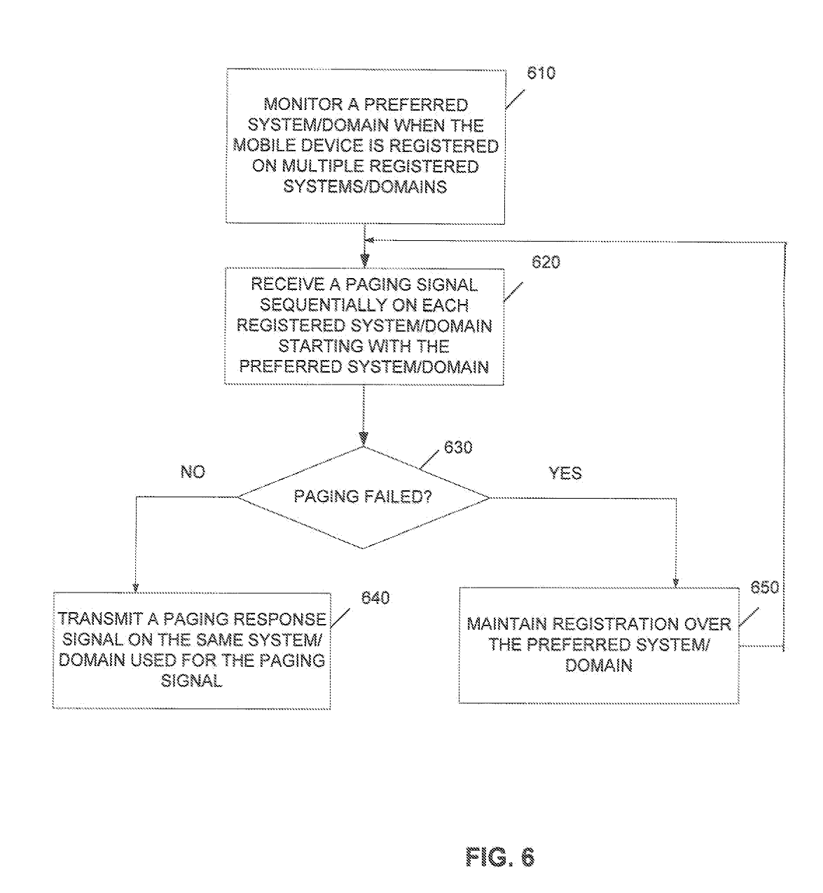

FIG. 6 is a block diagram illustrating a method to facilitate mobility of a mobile device over different domains within a network, according to an alternate embodiment of the invention. In one embodiment, the mobile device 300, also known interchangeably as user equipment (UE), uses a single public identity 430 with a single or, in the alternative, with dual private identities 420 that are used to perform IMS registrations over the WLAN and the WWAN systems/domains. As shown in FIG. 6, at processing block 610, a preferred system/domain is monitored. In one embodiment, the mobile device/UE 300 is dual registered on both the WLAN/IMS and CS networks and is monitoring a preferred system/domain for paging signals, the preferred system/domain being provisioned within the mobile device 300. In one embodiment, the network performs a sequential paging starting with the preferred system/domain and, on failing to get a response, tries to transmit a paging signal on the other system/domain.

At processing block 620, a paging signal is received sequentially on each registered system/domain, starting with the preferred system/domain. In one embodiment, the mobile device 300 receives a paging signal on the preferred system/domain and sequentially on the remaining systems/domains.

At processing block 630, a decision is made whether the paging over the preferred system has failed. In one embodiment, when a page over the preferred system/domain fails and is acquired over the other system/domain, the network may optimize by not paging the mobile device 300 over the preferred system/domain until the mobile device 300 performs another IMS registration over the preferred system/domain. This is different from deregistering the mobile device 300 from the preferred system. Subsequent pages will be tried over the non-preferred system/domain and when it fails, the network may retry the call over the preferred system/domain, as the mobile device 300 has not yet performed an explicit deregistration of the preferred system/domain and the registration timer has not yet expired.

In one exemplary embodiment, deployments may face the limitation that, until the IMS registration expires, for example, the call will be tried over the WLAN domain and, when it fails, it may be retried over the CS domain. Sequential paging, based on the timeout value chosen for receiving the paging response signal, may result in the mobile device 300 receiving the paging signal over both systems/domains. In such an example, the network accounts for receiving the page response signal on both systems/domains and establishes the call on the domain where the page response signal is received.

Referring back to FIG. 6, if the paging has not failed, at processing block 640, a paging response signal is transmitted by the mobile device 300 over the same system/domain used to transmit the paging signal. Otherwise, if the paging has failed, at processing block 650, the mobile device 300 maintains the registration over the preferred system/domain and processing blocks 620 through 650 are repeated.

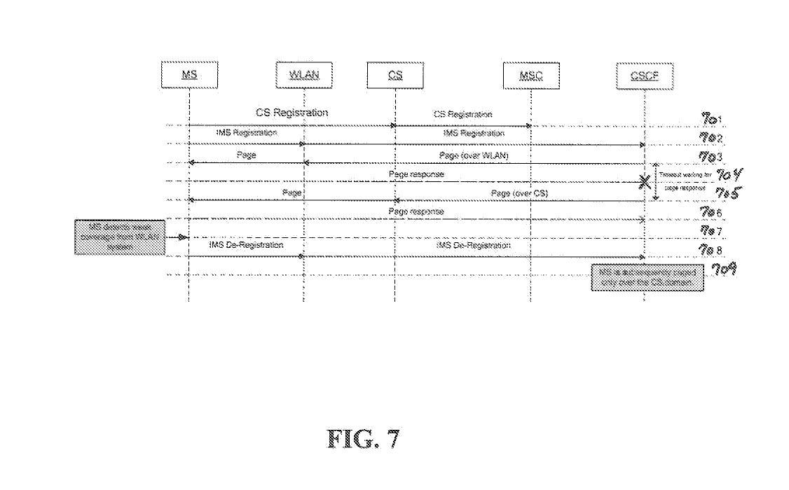

FIG. 7 is an interaction diagram for a method to facilitate mobility of a mobile device over different domains within a network, according to one embodiment of the invention. As illustrated in FIG. 7, in one embodiment, the mobile device 300 travels between the IMS and CS domains and is paged for mobile terminated calls. The mobile device 300 has a single public/private identity and is registered over the CS and the IMS systems/domains. In one embodiment, the mobile device 300 prefers the IMS domain and monitors only the IMS domain. The trigger is activated when the mobile device 300 receives an incoming paging signal. Referring to FIG. 7, the procedure is as follows:
Step 701: In one embodiment, the mobile device 300 performs a registration over the CS domain.
Step 702: In one embodiment, the mobile device 300 enters WLAN coverage and performs an IMS registration.
Step 703: In one embodiment, the CSCF receives the incoming page, which is forwarded to the mobile device 300 over the IMS/WLAN domain.
Step 704: In one embodiment, if the mobile device 300 receives the page over the IMS/WLAN domain, then it responds to the page. The call proceeds over the IMS domain.
Step 705: In one embodiment, if the CSCF did not receive the page response within a timeout period, it forwards the page through the media gateway to the CS domain.
Step 706: In one embodiment, the mobile device 300, having gone out of WLAN coverage, is monitoring the CS domain. The mobile device 300 receives the page and responds by sending the page response over the CS domain. The call is established over the CS domain.
Step 707: In one embodiment, in order to avoid the delays incurred due to sequential paging under transition scenarios, the mobile device 300 detects that the mobile is going out of WLAN coverage and performs IMS deregistration to stop receiving services over WLAN.
Step 708: In an alternate embodiment, the mobile device 300 sends an IMS de-registration, while still under weakened WLAN coverage.
Step 709: The mobile is subsequently paged only over CS domain.

In one embodiment, the mobile device 300 is paged over the appropriate domain based in its current registration status. When a failure occurs over the preferred system/domain, the call is retried over the other system/domain. In one embodiment, when a page over the preferred system/domain fails and is acquired over the other system/domain, the network may optimize by not paging the mobile device 300 over the preferred system/domain until the mobile device 300 performs another IMS registration over the preferred system/domain. This is different from deregistering the mobile device 300 from the preferred system. Subsequent pages will be tried over the non-preferred system/domain and when it fails, the network may retry the call over the preferred system/domain, as the mobile device 300 has not yet performed an explicit deregistration of the preferred system/domain and the registration timer has not yet expired.

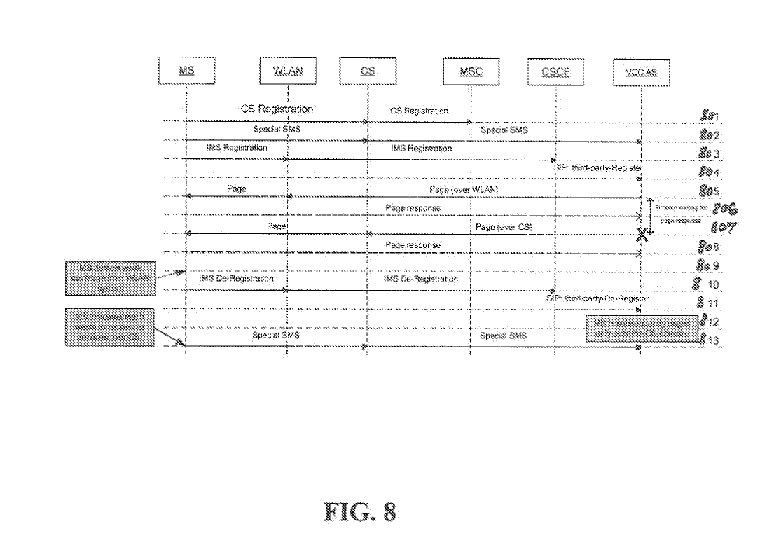

FIG. 8 is an interaction diagram for a method to facilitate mobility of a mobile device over different domains within a network, according to an alternate embodiment of the invention. In this embodiment, the mobile device 300 travels between the IMS and CS domains and is paged for mobile terminated calls. The mobile device 300 has a single public/private identity and is registered over the CS and the IMS systems/domains. In one embodiment, the mobile device 300 prefers the IMS domain and monitors only the IMS domain. The trigger is activated when the mobile device 300 receives an incoming paging signal. Referring to FIG. 8, the procedure is as follows:
Step 801: In one embodiment, the mobile device 300 performs a registration over the CS domain.
Step 802: In one embodiment, the mobile device 300 sends a special SMS to the VCC AS to indicate the domain where the mobile is willing to receive its incoming pages.
Step 803: In one embodiment, the mobile device 300 enters WLAN coverage and performs an IMS registration.
Step 804: In one embodiment, the CSCF forwards the IMS registration to the VCC AS to indicate that the mobile device 300 is willing to receive its incoming pages over the IMS domain.
Step 805: In one embodiment, the CSCF receives the incoming page, which it forwards to the VCC AS. The VCC AS pages the mobile device 300 over the IMS/WLAN domain.
Step 806: In one embodiment, if the mobile device 300 receives the page over the IMS/WLAN domain, it then responds to the page. The call proceeds over the IMS domain.
Step 807: In one embodiment, if the VCC AS did not receive the page response within a timeout period, it pages the mobile device 300 over the CS domain. The VCC AS still expects the page response from the mobile device 300 over the IMS/WLAN domain, as it may be delayed more than the timeout period.
Step 808: In one embodiment, the mobile device 300, having gone out of the WLAN coverage, is monitoring the CS domain. It receives the page and responds by sending the page response over the CS domain. The call is subsequently established over the CS domain.
Step 809: In one embodiment, in order to avoid the delays incurred due to sequential paging under transition scenarios, the mobile device 300 may detect that the mobile is going out of WLAN coverage and may perform IMS deregistration to stop receiving its services over WLAN.
Step 810: In one embodiment, the mobile device 300 sends an IMS de-registration, while still under weakened WLAN coverage.
Step 811: In one embodiment, the CSCF forwards the IMS de-registration to the VCC AS.
Step 812: In one embodiment, the mobile device 300 is subsequently paged only over CS domain.
Step 813: In one embodiment, if the mobile device 300 leaves the IMS/WLAN domain without having the chance to de-register, the mobile device 300 uses the special SMS to indicate to the VCC AS that it wants to receive its incoming pages over the CS domain. If this special SMS is not supported and the mobile device 300 did not perform an IMS de-registration, then the mobile device 300 is paged over the IMS/WLAN domains, fails and retries the call over the CS domain until the IMS registration times out.

In one embodiment, the mobile device 300 is paged over the appropriate domain based in its current registration status. When a failure occurs over the preferred system/domain, the call is retried over the other system/domain. In one embodiment, when a page over the preferred system/domain fails and is acquired over the other system/domain, the network may optimize by not paging the mobile device 300 over the preferred system/domain until the mobile device 300 performs another IMS registration over the preferred system/domain. This is different from deregistering the mobile device 300 from the preferred system. Subsequent pages will be tried over the non-preferred system/domain and when it fails, the network may retry the call over the preferred system/domain, as the mobile device 300 has not yet performed an explicit deregistration of the preferred system/domain and the registration timer has not yet expired.

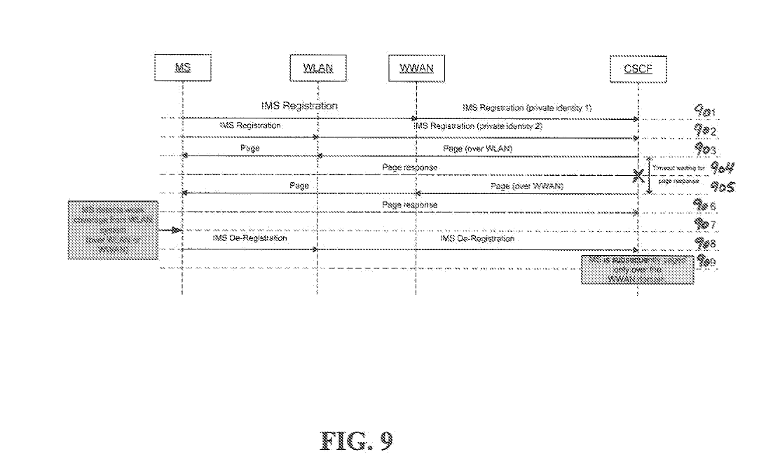

FIG. 9 is an interaction diagram for a method to facilitate mobility of a mobile device over different domains within a network, according to another alternate embodiment of the invention. In this embodiment, the mobile device 300 travels between the IMS/WLAN and IMS/WWAN domains and is paged for mobile terminated calls. The mobile device 300 has a single public identity with dual private identities and is registered over the IMS/WLAN and the IMS/WWAN systems/domains. In one embodiment, the mobile device 300 prefers the IMS/WLAN domain and monitors only the IMS/WLAN domain. The trigger is activated when the mobile device 300 receives an incoming paging signal. Referring to FIG. 9, the procedure is as follows:
Step 901: In one embodiment, the mobile device 300 performs a registration over the IMS/WWAN domain with private identity 1.
Step 902: In one embodiment, the mobile device 300 enters WLAN coverage and performs an IMS/WLAN domain registration with private identity 2.
Step 903: In one embodiment, the CSCF receives the incoming page, which it forwards to the VCC AS. The VCC AS treats IMS/WLAN as the preferred domain and pages the mobile device 300 over the IMS/WLAN domain.
Step 904: In one embodiment, if the mobile device 300 receives the page over the IMS/WLAN domain, it responds to the page. The call proceeds over the IMS/WLAN domain.
Step 905: In one embodiment, if the CSCF did not receive the page response within a timeout period, it pages the mobile device 300 over the IMS/WWAN domain.
Step 906: In one embodiment, the mobile device 300 receives the page and responds by sending the page response over the IMS/WWAN domain. The call is established over the IMS/WWAN domain.
Step 907: In one embodiment, the mobile device 300, having gone out of WLAN coverage, is monitoring the IMS/WWAN domain. In order to avoid the delays incurred due to sequential paging under transition scenarios, the mobile device 300 may detect that the mobile is going out of WLAN coverage and may perform IMS deregistration to stop receiving its services over WLAN.
Step 908: In one embodiment, the mobile device 300 sends an IMS de-registration while still under weakened WLAN coverage. The mobile device 300, when it loses the WLAN coverage prior to de-registration, may use the IMS/WWAN domain to de-register its IMS/WLAN domain, if both WLAN and WWAN IMS belong to the same IMS core network.
Step 909: In one embodiment, the mobile device 300 is subsequently paged only over IMS/WWAN domain.

In one embodiment, the mobile device 300 is paged over the appropriate domain based in its current registration status. When a failure occurs over the preferred system/domain, the call is retried over the other system/domain. In one embodiment, when a page over the preferred system/domain fails and is acquired over the other system/domain, the network may optimize by not paging the mobile device 300 over the preferred system/domain until the mobile device 300 performs another IMS registration over the preferred system/domain. This is different from deregistering the mobile device 300 from the preferred system. Subsequent pages will be tried over the non-preferred system/domain and when it fails, the network may retry the call over the preferred system/domain, as the mobile device 300 has not yet performed an explicit deregistration of the preferred system/domain and the registration timer has not yet expired.

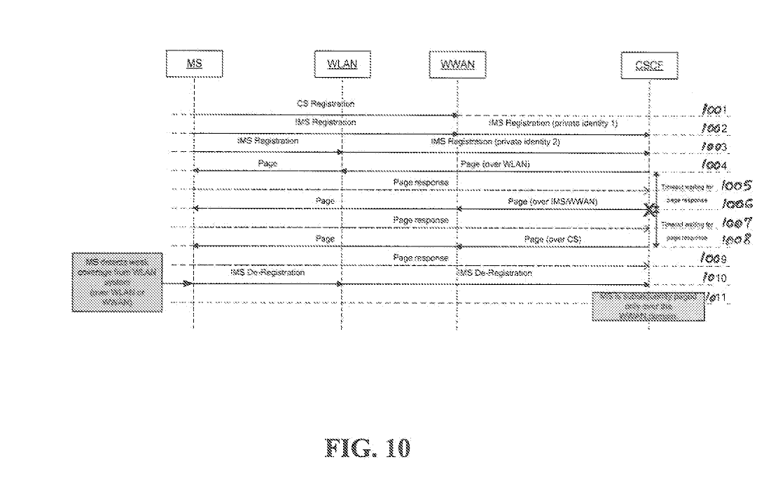

FIG. 10 is an interaction diagram for a method to facilitate mobility of a mobile device over different domains within a network, according to a further alternate embodiment of the invention. In this embodiment, the mobile device 300 travels between the IMS/WLAN and IMS/WWAN domains and is paged for mobile terminated calls. The mobile device 300 has a single public identity with dual private identities and is registered over the CS, the IMS/WLAN, and the IMS/WWAN systems/domains. In one embodiment, the mobile device 300 prefers the IMS/WLAN domain and monitors only the IMS/WLAN domain. In one embodiment, the domain preference for voice communications is IMS/WLAN, followed by IMS/WWAN, and further followed by the CS domain. The trigger is activated when the mobile device 300 receives an incoming paging signal. Referring to FIG. 10, the procedure is as follows:
Step 1001: In one embodiment, the mobile device 300 performs a registration over the CS domain.
Step 1002: In one embodiment, the mobile device 300 performs a registration over the IMS/WWAN domain with private identity 1.
Step 1003: In one embodiment, the mobile device 300 enters WLAN coverage and performs an IMS/WLAN domain registration with private identity 2.
Step 1004: In one embodiment, the CSCF receives the incoming page, it treats IMS/WLAN as the preferred domain, and further pages the mobile device 300 over the IMS/WLAN domain.
Step 1005: In one embodiment, if the mobile device 300 receives the page over the IMS/WLAN domain, it responds to the page. The call proceeds over the IMS/WLAN domain.
Step 1006: In one embodiment, if the CSCF did not receive the page response within a timeout period, it pages the mobile device 300 over the IMS/WWAN domain.
Step 1007: In one embodiment, the mobile device 300, having gone out of WLAN coverage, is monitoring the IMS/WWAN domain. It receives the page and responds by sending the page response over the IMS/WWAN domain. The call is subsequently established over the IMS/WWAN domain.
Step 1008: In one embodiment, if the CSCF did not receive the page response within a timeout period for the page sent over the IMS/WWAN domain, it pages the mobile device 300 over the CS domain.
Step 1009: In one embodiment, in order to avoid the delays incurred due to sequential paging under transition scenarios, the mobile device 300 may detect that the mobile is going out of WLAN coverage and may perform IMS deregistration to stop receiving its services over WLAN. The mobile device 300 sends a IMS de-registration while still under weakened WLAN coverage. The mobile device 300, when it loses the WLAN coverage prior to de-registration, may use the IMS/WWAN domain to de-register its IMS/WLAN domain, if both WLAN and WWAN IMS belong to the same IMS core network.
Step 1010: In one embodiment, the mobile device 300 is subsequently paged only over IMS/WWAN or CS domains.

In one embodiment, the mobile device 300 is paged over the appropriate domain based in its current registration status. When a failure occurs over the preferred system/domain, the call is retried over the other system/domain. In one embodiment, when a page over the preferred system/domain fails and is acquired over the other system/domain, the network may optimize by not paging the mobile device 300 over the preferred system/domain until the mobile device 300 performs another IMS registration over the preferred system/domain. This is different from deregistering the mobile device 300 from the preferred system. Subsequent pages will be tried over the non-preferred system/domain and when it fails, the network may retry the call over the preferred system/domain, as the mobile device 300 has not yet performed an explicit deregistration of the preferred system/domain and the registration timer has not yet expired.

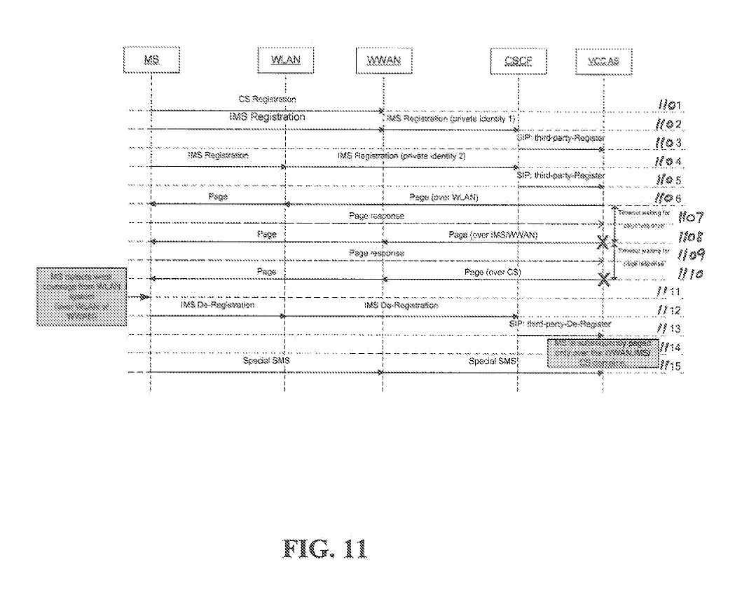

FIG. 11 is an interaction diagram for a method to facilitate mobility of a mobile device over different domains within a network, according to yet another alternate embodiment of the invention. In this embodiment, the mobile device 300 travels between the IMS/WLAN and IMS/WWAN domains and is paged for mobile terminated calls. The mobile device 300 has a single public identity with dual private identities and is registered over the CS, the IMS/WLAN, and the IMS/WWAN systems/domains. In one embodiment, the mobile device 300 prefers the IMS/WLAN domain and monitors only the IMS/WLAN domain. In one embodiment, the domain preference for voice communications is IMS/WLAN, followed by IMS/WWAN, and further followed by the CS domain. The trigger is activated when the mobile device 300 receives an incoming paging signal. Referring to FIG. 11, the procedure is as follows:
Step 1101: In one embodiment, the mobile device 300 performs a registration over the CS domain.
Step 1102: In one embodiment, the mobile device 300 performs a registration over the IMS/WWAN domain with private identity 1.
Step 1103: In one embodiment, the CSCF forwards the IMS/WWAN registration to the VCC AS to indicate that the mobile device 300 is willing to receive its incoming pages over the IMS/WWAN domain.
Step 1104: In one embodiment, the mobile device 300 enters WLAN coverage and performs an IMS/WLAN domain registration with private identity 2.
Step 1105: In one embodiment, the CSCF forwards the IMS/WLAN registration to the VCC AS to indicate that the mobile device 300 is willing to receive its incoming pages over the IMS/WLAN domain.
Step 1106: In one embodiment, the CSCF receives the incoming page, which it forwards to the VCC AS. The VCC AS treats the IMS/WLAN domain as the preferred domain and pages the mobile device 300 over the IMS/WLAN domain.
Step 1107: In one embodiment, if the mobile device 300 receives the page over IMS/WLAN, it responds to the page. The call proceeds over the IMS/WLAN domain.
Step 1108: In one embodiment, if the VCC AS did not receive the page response within a timeout period, it pages the mobile device 300 over the IMS/WWAN domain.
Step 1109: In one embodiment, the mobile device 300, having gone out of WLAN coverage, is monitoring the IMS/WWAN domain. It receives the page and responds by sending the page response over the IMS/WWAN domain. The call is established over the IMS/WWAN domain.
Step 1110: In one embodiment, if the CSCF did not receive the page response within a timeout period for the page sent over the IMS/WWAN domain, it pages the mobile device 300 over the CS domain.
Step 1111: In one embodiment, in order to avoid the delays incurred due to sequential paging under transition scenarios, the mobile device 300 may detect that the mobile is going out of WLAN coverage and may perform IMS deregistration to stop receiving its services over WLAN.
Step 1112: In one embodiment, the mobile device 300 sends an IMS de-registration while still under weakened WLAN coverage. The mobile device 300, when it loses the WLAN coverage prior to de-registration, may use the IMS/WWAN domain to de-register its IMS/WLAN domain if both WLAN and WWAN IMS belong to the same IMS core network.
Step 1113: In one embodiment, the CSCF forwards the IMS de-registration to the VCC AS.
Step 1114: In one embodiment, the mobile device 300 is subsequently paged only over IMS/WWAN or the CS domains.
Step 1115: In one embodiment, the mobile device 300 may use the Special SMS to indicate to the network that it wishes to receive all its services over CS domain only.

In one embodiment, the mobile device 300 is paged over the appropriate domain based in its current registration status. When a failure occurs over the preferred system/domain, the call is retried over the other system/domain. In one embodiment, when a page over the preferred system/domain fails and is acquired over the other system/domain, the network may optimize by not paging the mobile device 300 over the preferred system/domain until the mobile device 300 performs another IMS registration over the preferred system/domain. This is different from deregistering the mobile device 300 from the preferred system. Subsequent pages will be tried over the non-preferred system/domain and when it fails, the network may retry the call over the preferred system/domain, as the mobile device 300 has not yet performed an explicit deregistration of the preferred system/domain and the registration timer has not yet expired.

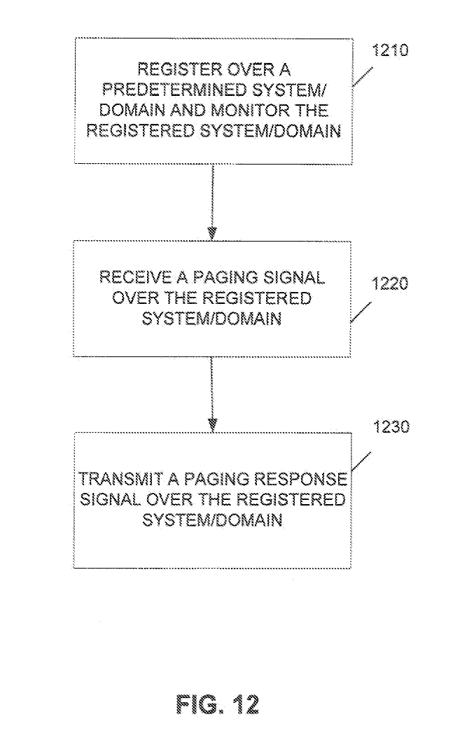

FIG. 12 is a block diagram illustrating a method to facilitate mobility of a mobile device over different domains within a network, according to another alternate embodiment of the invention. As shown in the embodiment of FIG. 12, at processing block 1210, the mobile device 300 registers over a predetermined system/domain and monitors the registered system/domain. In one embodiment, when the mobile device 300 registers over one system/domain, the device's registration is removed from the other system/domain. The mobile device 300 subsequently sends an SMS when it registers over the CS domain.

At processing block 1220, a paging signal is received over the registered system/domain. In one embodiment, the mobile device 300 receives the page from the network. The network pages the mobile device 300 on the currently registered domain. If the network does not get a response within a predetermined time period, then it gives up assuming the mobile device 300 is out of coverage. Otherwise, at processing block 1230, a paging response signal is transmitted over the registered system/domain by the mobile device 300.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions, (which may be referred herein as “software,” “computer software,” and/or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both a computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Accordingly, it should be appreciated that a computer-readable medium may be implemented in any suitable computer-program product.

The previous description of the disclosed aspects is provided to enable any person skilled in the art to make or use the present disclosure. Various modifications to these aspects may be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method comprising:
registering a mobile station with a preferred system/domain and a non-preferred system/domain; and
monitoring at least one of said preferred system/domain and said non-preferred system/domain for a paging signal.

2. The method of claim 1, wherein said monitoring further comprises:
monitoring said preferred system/domain and said non-preferred system/domain for said paging signal; and
simultaneously receiving said paging signal on both said preferred system/domain and said non-preferred system/domain.

3. The method of claim 2, further comprising:
transmitting a paging response signal in response to said paging signal on said preferred system/domain.

4. The method of claim 1, wherein said preferred system/domain is provisioned within said mobile station.

5. The method of claim 1, wherein said monitoring further comprises:
monitoring said preferred system/domain for said paging signal; and
receiving said paging signal on one of said systems/domains, said paging signal being sequentially transmitted on each system/domain starting with said preferred system/domain.

6. The method of claim 5, further comprising:
transmitting a paging response signal in response to said paging signal on said one system/domain used to receive said paging signal.

7. The method of claim 5, further comprising:
maintaining said registration over said preferred system/domain if said paging signal fails to reach said mobile station over said preferred system/domain.

8. The method of claim 1, wherein said mobile station uses a public identity and at least one associated private identity to perform registrations over said preferred and said non-preferred systems/domains.

9. The method of claim 1, wherein said monitoring further comprises:
removing said registration from a previously registered system/domain of said preferred system/domain and said non-preferred system/domain; and
monitoring said remaining currently registered system/domain.

10. The method of claim 9, further comprising:
receiving said paging signal over said remaining currently registered system/domain; and
transmitting a paging response signal in response to said paging signal over said remaining system/domain.

11. An apparatus comprising:
means for registering a mobile station with a preferred system/domain and a non-preferred system/domain; and
means for monitoring at least one of said preferred system/domain and said non-preferred system/domain for a paging signal.

12. The apparatus of claim 11, further comprising:
means for monitoring said preferred system/domain and said non-preferred system/domain for said paging signal; and
means for simultaneously receiving said paging signal on both said preferred system/domain and said non-preferred system/domain.

13. The apparatus of claim 12, further comprising:
means for transmitting a paging response signal in response to said paging signal on said preferred system/domain.

14. The apparatus of claim 11, wherein said preferred system/domain is provisioned within said mobile station.

15. The apparatus of claim 11, further comprising:
means for monitoring said preferred system/domain for said paging signal; and
means for receiving said paging signal on one of said systems/domains, said paging signal being sequentially transmitted on each system/domain starting with said preferred system/domain.

16. The apparatus of claim 15, further comprising:
means for transmitting a paging response signal in response to said paging signal on said one system/domain used to receive said paging signal.

17. The apparatus of claim 15, further comprising:
means for maintaining said registration over said preferred system/domain if said paging signal fails to reach said mobile station over said preferred system/domain.

18. The apparatus of claim 11, wherein said mobile station uses a public identity and at least one associated private identity to perform registrations over said preferred and said non-preferred systems/domains.

19. The apparatus of claim 11, further comprising:
means for removing said registration from a previously registered system/domain of said preferred system/domain and said non-preferred system/domain; and
means for monitoring said remaining currently registered system/domain.

20. The apparatus of claim 19, further comprising:
means for receiving said paging signal over said remaining currently registered system/domain; and
means for transmitting a paging response signal in response to said paging signal over said remaining system/domain.

21. A computer program product, comprising:
a computer-readable medium comprising:
code for causing a computer to register a mobile station with a preferred system/domain and a non-preferred system/domain; and
code for causing the computer to monitor at least one of said preferred system/domain and said non-preferred system/domain for a paging signal.

22. The computer program product of claim 21, wherein said computer-readable medium further comprises:
code for causing a computer to monitor said preferred system/domain and said non-preferred system/domain for said paging signal; and
code for causing a computer to receive simultaneously said paging signal on both said preferred system/domain and said non-preferred system/domain.

23. The computer program product of claim 22, wherein said computer-readable medium further comprises:
code for causing a computer to transmit a paging response signal in response to said paging signal on said preferred system/domain.

24. The computer program product of claim 21, wherein said preferred system/domain is provisioned within said mobile station.

25. The computer program product of claim 21, wherein said computer-readable medium further comprises:
code for causing a computer to monitor said preferred system/domain for said paging signal; and
code for causing a computer to receive said paging signal on one of said systems/domains, said paging signal being sequentially transmitted on each system/domain starting with said preferred system/domain.

26. The computer program product of claim 25, wherein said computer-readable medium further comprises:
code for causing a computer to transmit a paging response signal in response to said paging signal on said one system/domain used to receive said paging signal.

27. The computer program product of claim 25, wherein said computer-readable medium further comprises::
code for causing a computer to maintain said registration over said preferred system/domain if said paging signal fails to reach said mobile station over said preferred system/domain.

28. The computer program product of claim 21, wherein said mobile station uses a public identity and at least one associated private identity to perform registrations over said preferred and said non-preferred systems/domains.

29. The computer program product of claim 21, wherein said computer-readable medium further comprises:
code for causing a computer to remove said registration from a previously registered system/domain of said preferred system/domain and said non-preferred system/domain; and
code for causing a computer to monitor said remaining currently registered system/domain.

30. The computer program product of claim 29, wherein said computer-readable medium further comprises:
code for causing a computer to receive said paging signal over said remaining currently registered system/domain; and
code for causing a computer to transmit a paging response signal in response to said paging signal over said remaining system/domain.

31. A wireless communication device comprising:
a processor configured to register said device with a preferred system/domain and a non-preferred system/domain and to monitor at least one of said preferred system/domain and said non-preferred system/domain for a paging signal; and
a memory coupled to said processor.

32. The wireless communication device of claim 31, wherein said processor further monitors said preferred system/domain and said non-preferred system/domain for said paging signal, and simultaneously receives said paging signal on both said preferred system/domain and said non-preferred system/domain.

33. The wireless communication device of claim 32, wherein said processor further transmits a paging response signal in response to said paging signal on said preferred system/domain.

34. The wireless communication device of claim 31, wherein said preferred system/domain is provisioned within said device.

35. The wireless communication device of claim 31, wherein said processor further monitors said preferred system/domain for said paging signal, and receives said paging signal on one of said systems/domains, said paging signal being sequentially transmitted on each system/domain starting with said preferred system/domain.

36. The wireless communication device of claim 35, wherein said processor further transmits a paging response signal in response to said paging signal on said one system/domain used to receive said paging signal.

37. The wireless communication device of claim 35, wherein said processor further maintains said registration over said preferred system/domain if said paging signal fails to reach said mobile station over said preferred system/domain.

38. The wireless communication device of claim 31, wherein said device uses a public identity and at least one associated private identity to perform registrations over said preferred and said non-preferred systems/domains.

39. The wireless communication device of claim 31, wherein said processor further removes said registration from a previously registered system/domain of said preferred system/domain and said non-preferred system/domain, and monitors said remaining currently registered system/domain.

40. The wireless communication device of claim 39, wherein said processor further receives said paging signal over said remaining currently registered system/domain, and transmits a paging response signal in response to said paging signal over said remaining system/domain.
